(19) United States
(12) Patent Application Publication
(10) Pub. No.: US 2014/0134584 A1
(43) Pub. Date: May 15, 2014

(54) FITNESS ASSESSMENT METHOD AND SYSTEM

(71) Applicant: Barry French, Bay Village, OH (US)

(72) Inventor: Barry French, Bay Village, OH (US)

(21) Appl. No.: 14/077,619

(22) Filed: Nov. 12, 2013

Related U.S. Application Data
(60) Provisional application No. 61/725,188, filed on Nov. 12, 2012.
(60) Provisional application No. 61/748,298, filed on Jan. 2, 2013.
(60) Provisional application No. 61/960,916, filed on Sep. 30, 2013.

(51) Int. Cl. G09B 19/00

(52) U.S. Cl. CPC G09B 19/00
USPC 434/247

(57) ABSTRACT

An assessment of a subject's fitness is evaluated by having the subject go through whole body weight-bearing movement, with cuing provided to direct the subject's movements, and feedback provided to keep the subject at a desired exercise intensity. The subject's reaction to the exercise may be measured, for example with the subject's movements being tracked. An evaluation may be made, based at least in part on the measured reaction, for example by using data from the movement tracking, possibly in conjunction with data obtained by earlier testing, for example using a similar test protocol.

This application claims priority under 35 USC 119 to U.S. Provisional Application 61/725,188, filed Nov. 12, 2012, to U.S. Provisional Application 61/748,298, filed Jan. 2, 2013, and to U.S. Provisional Application 61/960,916, filed Sep. 30, 2013. All of above applications are incorporated herein by reference in their entireties.

### BACKGROUND OF THE INVENTION

1. Field of the Invention

The invention is in the field of fitness evaluation devices and methods.

2. Description of the Related Art

There is a widely recognized need for a tool to evaluate fitness for various reasons. One reason is to detect early signs of overtraining. Athletes at all levels are at risk for overtraining syndrome, where too much training actually has a negative effect on fitness.

Susceptibility to overtraining depends upon many variables, including training volume (intensity, duration, and frequency), physical conditioning, response to stress, and outside influence (family, job, concurrent illness or injury.)

### SUMMARY OF THE INVENTION

According to an aspect of the invention, a method of assessing a subject includes putting the subject through weight-bearing whole-body movement, while providing the subject feedback to maintain compliance with a desired exercise intensity, and while measuring the subject's response, for example including tracking the subject's movement.

According to another aspect of the invention, a method of assessing a subject includes the steps of: directing the subject to exercise by providing movement cues for whole-body movement, wherein the directing includes providing feedback to the subject during the directing, for the subject to maintain compliance with a desired exercise intensity; measuring subject response to the exercise; and evaluating the measured subject response.

According to other aspects of the invention, a fitness assessment system and/or method includes a system and/or method for repeatedly putting a subject through a fitness test of increasing physical intensity, while measuring subject response. The measuring of the subject response may include monitoring the subject's heart rate, such as through telemetry. Alternatively or in addition, the measuring of subject of subject response may include measuring and/or determining work rate of the subject. It also may include monitoring the subject's reaction time. The subject's response as a function of exercise intensity (both may be a function of time) may be examined, and compared with earlier assessments, to determine fitness of the subject.

According to other aspects of the invention, a system for carrying out any of the methods of the previous paragraphs may include one or more of the following features: the system includes a camera; the camera has variable focus; the system includes a processor operatively coupled to the camera, or to another sensor, for tracking movement of the person; the system performs beaconless tracking of the person; the system includes a display for displaying to the person; the display includes a representation of a physical space in which movement of the person is tracked; and/or the display includes an avatar, movement of which corresponds to movement of the person in the physical space. As an alternative to a camera, other suitable means of tracking the subject's movement way be used.

According to other aspects of the invention, a system for carrying out any of the methods of the previous paragraphs may include one or more of the following features: the system includes a camera; the camera has variable focus; the system includes a processor operatively coupled to the camera, or to another sensor, for tracking movement of the person; the system performs beaconless tracking of the person; the system includes a display for displaying to the person; the display includes a representation of a physical space in which movement of the person is tracked; and/or the display includes an avatar, movement of which corresponds to movement of the person in the physical space. Again, as an alternative to a camera, other suitable means of tracking the subject's movement way be used.

According to still other aspects of the invention, a fitness assessment system and/or method includes a system and/or method for repeatably putting a subject through a fitness test of increasing physical intensity, while measuring subject response. The measuring of the subject response may include monitoring the subject's heart rate, such as through telemetry. It also may include monitoring the subject's reaction time. The subject response as a function of exercise intensity (both may be a function of time) may be examined, and compared with earlier assessment, to determine fitness of the subject.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

The annexed drawings, which are not necessarily to scale, show various aspects of the invention.

FIG. 1 is an oblique view of a system in accordance with the present invention.

FIG. 2 is a graph of work rate versus time, showing example results for an embodiment of the invention.

FIG. 3 is a graph of heart rate versus time for the embodiment of FIG. 2.

FIG. 4 is a graph that combines the information of the graphs of FIGS. 2 and 3.

FIG. 5 is an illustration of one displayable device for providing a test subject with feedback on exercise level.

FIG. 6 is an illustration of another displayable device for providing a test subject with feedback on exercise level.

FIG. 7 is an illustration of a screen on a display device, for providing movement cues and feedback to maintain desired exercise intensity.

FIG. 8 is a graph showing a (representative) training cycle for a training program that has resulted in performance degradation for the subject.

FIG. 9 is a graph showing a (representative) training cycle that results in performance improvement.

FIG. 10 shows an example a report screen.

FIG. 11 shows a report screen with a first data point of an example series of training sessions.

FIG. 12 shows a report screen with a second data point added for the example series of training sessions.

FIG. 13 shows a report screen with a third data point added for the example series of training sessions.

FIG. 14 shows a report screen with a fourth data point added for the example series of training sessions.

### DETAILED DESCRIPTION

An assessment of a subject's fitness is evaluated by having the subject go through whole body weight-bearing movement, with cuing provided to direct the subject's movements, and feedback provided to keep the subject at a desired exercise intensity. The subject's reaction to the exercise may be measured, for example with the subject's movements being tracked. An evaluation may be made, based at least in part on the measured reaction, for example by using data from the movement tracking, possibly in conjunction with data obtained by earlier testing, for example using a similar test protocol.

In the following description, much of the initial discussion is in terms of cognitive function and cognitive function evaluation (and related concepts). It should be appreciated that such cognitive function is not necessarily a part of the fitness assessment that is discussed later in the description.

A cognitive function evaluation method and system involves prompting a test subject (person) to engage in movement, such as whole-body movement, for example sports-specific movement, while tracking movement of the person. Data can be gathered from the tracking of the person's movement. This data can be compared with baseline data from an earlier test (or with data gathered from other subjects), to make a determination of cognitive function of the test subject, or to evaluate progress in rehabilitation and/or aid in making a determination whether a person is ready to resume specified activities, such as an athlete returning to a sport. Such a determination can be made under realistic activity-specific conditions (for example using increased metabolic rate and/or activity-specific movements that may test/challenge the test subjects cognition, vestibular, and/or visual performance/abilities), to allow a for determination of the person's cognitive function. Specific movements that challenge visual/vestibular performance, such as turning movements or changes in elevation (such as upward and downward movements of the head) may be used to provide a better determination of cognitive function. Certain movements, such as reaction time tests for movements in various directions, may be used to help differentiate between performance reductions due to impair neurological function, and performance reductions for other reasons, such as orthopedic injuries, for example knee or ankle injuries.

A system for prompting user movement, tracking response, is the TRAZER system. An example of such a system is described in U.S. Pat. No. 7,359,121, which is incorporated herein by reference in its entirety. The TRAZER system is a physical activity system (a testing, training, recreational, and/or evaluation system) that includes a tracking system for determining changes in overall physical locations of a user (person or subject), and a processor or computer operatively coupled to the tracking system for updating a user virtual locations in a virtual space, a physical locations of the user. The TRAZER system may include a monitor or display, of any of various types, for providing information to a user of the system. The system may prompt movement in any of a variety of ways, provide feedback in a display, and gather data by tracking body movement in any of a variety of ways. Further details regarding the system, and the many body movements that may be prompted, and data that may be gathered, are described in the above patent.

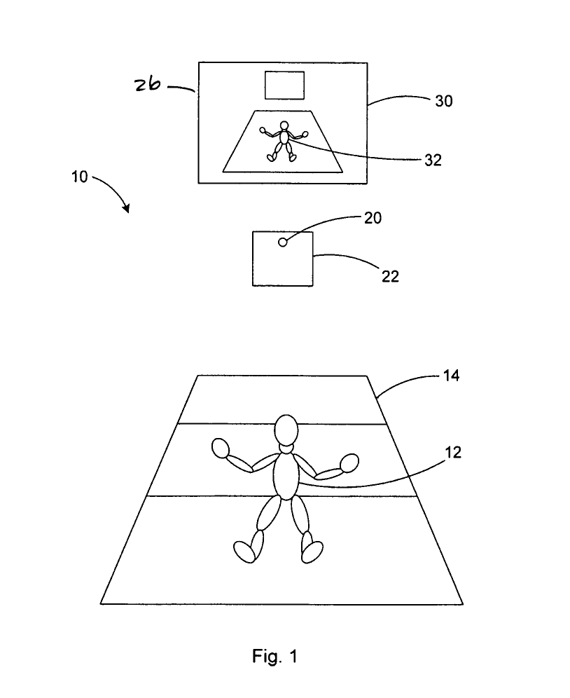

FIG. 1 shows an example of a system 10, in some ways similar to the TRAZER system, which prompts full body movement of a person 12, in a physical space 14, which may or may not be visually delineated, and which need not have definite boundaries. Movement of the person 12 is detected and tracked by a camera or other sensor 20 in a base unit 22, which may include other components such as a processor, communication ability, data storage, etc. The camera or other sensor 20 may have an adjustable field for tracking the person 12, for example be adjustable to track in an area range from 36 square feet to 400 square feet. A display 26 is used to display a view 30 to the user 12, or to otherwise prompt full body motion to be tracked by the base unit 22. The view 30 may show an avatar 32 that represents movement of the user 12 in the physical space 14.

Numerous suitable 3-dimensional tracking devices (cameras) are commercially available. Such devices include suitable cameras from Asus, Panasonic and MS Windows versions of the Kinect. Extracting 3-dimensional positional information from such cameras, as well as moving an (virtual) avatar representing the subject being tracked, is also well known by those possessing ordinary skill in the art.

The system 10 may also enable continuous, 360 degree body tracking of the athlete. A body-worn beacon, often used in prior systems, can often be dispensed with. Even without a beacon, the system 10 may be able to uniquely track certain types of movement that may be important for the sensitive and accurate assessment of a concussed athlete, or for another subject for neurological evaluation. The use of a 3D camera measuring depth eliminates the need for a body-worn beacon that previously precluded the reliable, continuous tracking of body movements such as body rotations and elevation changes. Body rotations refers to movements where the athlete (or person or subject) is turning away from the system 10 display by varying degrees. Such rotations may include full 360 degree turning.

Elevation changes are up or down changes in body locations. Prior patents involving the movement-tracking system (see the patent above, and other patents in its chain of priority) disclose the tracking of the user's CG (center-of-gravity), which was measurable in the some versions of the movement-tracking system by a body-worn beacon maintained line-of-sight with one or more sensors or other receiving elements. This required the athlete (user) to hold his or her torso in an erect posture—elevation changes were measured when the subject's legs either bent or the subject jumped. It has been found that vertical transgressions that involve the athlete dropping (approximately) his/her head below their heart level; which can occur when the athlete moves from a 3 or 4 point stance, reaches down to pick up a ball, etc., serves to more realistically challenge the athlete's sensory and vestibular systems.

The aforementioned types of movement add sophistication/realism to concussion or other neurological assessment. Some of these measurements, such as 360 degree body tracking of the subject, may also be accomplished in a system that utilizes one or more beacons on the subject. It will be appreciated that changes in location over time can easily be translated into velocities, speeds, and accelerations.

A test protocol that assists in determining whether a measured degradation of global performance is caused, at least in part, from either a brain injury, orthopedic injury or maybe a contribution from both. Sensitivity and reliability of the assessment may benefit from the ability to determine whether an observed degradation of global performance is actually attributable to the effects of a brain injury.

A concussion may represent a diffused change in the metabolic state of the brain—that it is not a focal structural injury. As such, a global brain injury may result in degradation of global performance, as contrasted to a “focal” orthopedic injury or focal brain injury (a stroke) that results in vector-specific movement deficits.

There are, of course, many factors that may be attributable to differences between the athlete's preseason baseline test and testing employed post a concussion during season. Physical conditioning is just one potentially confounding factor.

By using the system 10 to analyze movement capabilities in each vector direction, it has been found that orthopedic injuries, especially lower extremity injuries, often produce movement deficits in defined movement vector. For example, moving off an injured right knee may inhibit reaction time and acceleration when the athlete is moving to the left, and may exhibit compromised deceleration capabilities when the athlete is moving to the right. Diminished reaction time as a result of an orthopedic injury may result from deterring pain, confidence and/or loss of proprioception; additionally acceleration/rate of force production deficits may also be observed.

Use of the system 10 to evaluate cognitive or neurological function contrasts with current tests employed to assess the concussed athlete's ability to return to play, which measure isolated capabilities. The system 10 has been employed to evaluate/assess the athlete's global athletic performance capabilities which may be compromised in the concussed athlete, or with those who have otherwise suffered cognitive or neurological deficits. The use of the system 10 in evaluation involves holistic approach to concussion assessment is in recognition that the status of the athlete (or other subject) cannot be understood solely in terms of its component parts.

Both orthopedic injuries, especially of the lower extremity, as well as brain injuries that act to impede the neurological system from properly signaling the musculoskeletal system, may affect the athlete's global athletic performance capabilities. The system 10 provides the interactive virtual environment and the measurement means to enable the clinician, trainer or coach to view disability and capability as a continuum of the capacity for movement. A concussion tends to degrade system-wide performance, in contrast to a lower extremity orthopedic injury that may act to degrade movement substantially in defined movement vectors.

In an improved method and system, such as described herein, for example using the system 10, a novel assessment protocol may be employed, using simulation to both measure global athletic performance and to assist the clinician in determining as to whether measured degradations (relative, for example, to a previously-performed baseline test) are resulting from a brain injury, orthopedic injury or both. Since returning a concussed athlete to play prematurely can result in catastrophic consequences, such information may assist the clinician in interpreting the available test data when making a return-to-play decision.

There are distinct advantages of assessing global performance in contrast to isolated capacities. The system and method described herein uniquely assesses the athlete's work capacity (the ability to sustain exercise while maintaining heart rate (or other indicators of metabolic rate) below a certain level), via the measurement of movement speed and heart rate, which is compared to the athlete's baseline assessment that was performed when the athlete was deemed healthy. Reaction time serves as a measure of sensory/cognitive prowess. The continuous measurement of the subject's movement speed and heart rate allows objective documenting work capacity, which can be compared to the subject's baseline (healthy) test results. Normative data can also used for comparison. A diminished capacity for work in a test after an event serves as a significant sign of neurological injury.

One goal in the present evaluation system and method is to assess the athlete's global performance capabilities that may be negatively affected as a direct result of a concussion. In addition the system and method may be capable of identifying potentially confounding factor(s) to that may contribute to diminished global performance. For example, a lower extremity orthopedic injury during season may impact the athlete's ability for movement that is obviously unrelated to diminished sensory/cognitive processes post concussion. Another possible confounding factor is that the athlete's present level of physical conditioning may differ from their preseason baseline due to either the rigors of the competitive season or as a direct result of the post concussion protocol that prescribes the athlete refrain from (minimally) vigorous exercise. To assist in identifying the impact of such confounding factors, the system and method provides means to assist in determining if the athlete's measured decline in work capacity may be related to a lower extremity orthopedic issue, or a more global decline as a result of a possible brain injury. It is possible that physical conditioning may have less impact on reaction time than the ability to generate high rates of force production (essentially acceleration). Therefore observing reaction time (collecting data on reaction time), and comparing reaction time versus a previous baseline (comparing data on reaction time versus baseline data on reaction time).

A brain injury may typically results in a universal (global) loss of the capacity for movement, rather than a “significant” deficit in a given movement vector. Accordingly, the ability to detect asymmetric movement patterns may serve to identify orthopedic issues that can negatively affect global performance. Such asymmetrical movement patterns may, for example, be the result of deterring pain, lack of confidence and/or proprioception in the injured limb as the subject attempts to accelerating off said limb. Both reaction time and acceleration specific to this vector may be diminished. The approach described herein may improve test sensitivity by the generation of movement-specific performance data to detect an “isolated” orthopedic deficit. Testing for symmetry of movement deficits could be performed for both baseline and post concussion return-to-play.

The system 10 descried herein creates/replicates the physical demands of sport competition to measure “global athletic performance”. In contrast to the assessment of isolated capacities, simulation acts to challenge the athlete's visual, cognitive, neuromuscular, and vestibular systems by eliciting 360 degree movement responses that act to elevate the athlete's metabolic rate to game levels while measuring reaction times to spontaneous cues, heart rate and multi-vector movement velocity. This measurement of work can be compared to previous baseline tests. Thus the system and method offer a novel global athletic performance assessment protocol for return to play decisions. Continuous measurement of heart rate and movement velocity in each vector direction gauges the athlete's work capacity as a measure of the athlete's compliance with the test protocol, which can be compared to baseline tests.

In the system 10, the athlete's perceptual (sensing) ability is not tested in isolation, but rather as the initial stage of a continuum of capabilities ranging from the ability to recognize and interpret sport-relevant visual information, to the ability to adeptly execute, when desired, in a kinematically correct manner. The athlete's visual and cognitive skills are challenged by sensing and responding to sports simulations that demand the athlete undertake the “correct” pursuit angle.

Injury to the vestibular system can directly create cognitive deficits and spatial navigation issues. The athlete responds to cues provided by the system 10, with rotations, translations and vertical changes of body position, each vector of movement may act somewhat differently on the vestibular system. The vestibular system contributes to balance and a sense of spatial orientation, essential components of effective athletic movement.

The approach described herein uniquely challenges the athlete's sensory and vestibular (balance) systems. With the system 10, the athlete responds with rotations, translations and vertical changes of body position to undertake the “correct” pursuit angle. This pursuit angle is known to the system 10. Unlike static balance tests, aspects of depth perception, dynamic visual acuity, peripheral awareness and anticipation skills are assessed during realistic movement.

With an adjustable (modifiable) physical movement area, the assessment environment can uniquely replicate the movement patterns of game play, other athletic activity, or other task-specific activity. The assessment incorporates aspects of depth perception, dynamic visual acuity, peripheral awareness, anticipation skills, etc. Assessment of Dynamic Visual Acuity has been shown to be an excellent predictor of recovery from concussion. Unlike static tests, the systems and methods described herein uniquely assess aspects of Dynamic Visual Acuity by causing the athlete's head to be moved in space in a sport-specific manner.

Also material to test validity is the unpredictably of the stimuli delivered to the athlete over multiple tests. Randomizing software algorithms may be used to ensure that the athlete cannot correctly anticipate subsequent movement challenges.

Another advantage is that the interactive, game-like interface coupled to real time feedback also acts to improve the athlete's compliance with the testing or training protocol. Motivation is reported frequently as a recognized deficit of sedentary cognitive testing protocols.

Further, in contrast to specialized tests of cognition with a singular purpose, the system's versatility affords the clinician, trainer or coach many opportunities to collect baseline data for more accurate characterizations of the athlete's baseline global performance. For example, sports simulation provides unrivaled testing and training opportunities during the athlete's strength and conditioning and rehabilitation sessions. The system 10 may thus serve as a data collection, analysis and reporting system that detects movement (performance) abnormalities and weaknesses.

Many other variations are possible. The above system and steps may also be employed as part of a rehabilitation process, for example in rehabilitating an athlete from an injury such as a concussion. The system 10 may be used for controlled rehabilitation of an injured person, and for aiding in determining when the person is ready to resume specified activities, such as a team sport or other athletic activity. Comparisons can be made relative to a baseline (pre-injury) test, or alternatively relative to data from other persons, for example data from similar types of athletes, such as those with similar body types and/or skills.

Resting heart rate for a healthy young athlete may be 45-70 beats per minute (bpm), for example. During a sport and/or task the heart rate may raise considerably, for example a basketball player on a fast break may achieve a heart rate in excess of 150 to 180 bpm. When testing post concussion to compare to a baseline (or normative data), it is beneficial for the athlete to reach a heart rate commensurate to levels achieved in actual competition. Combining a system for prompting movement, with feedback concerning heart rate, allows this to be accomplished. The measurement of heart rate and movement speed may be used as indicators of the athlete's capacity for work. For example, assume an athlete's baseline test measured a maximum velocity of 6.2 ft/sec, maximum heart rate of 185 bpm, and average reaction time of 0.7 sec. If the athlete post concussion achieves these baseline levels without symptoms, it may be assumed that he or she is now “fit to play”.

The system 10 and methods described above may be used for rehabilitation, such as for recovery from a concussion or other neurological injury. By controlling performance through use of prompts for user movement, and by measuring response through tracking, the progression of the rehabilitation process can be controlled. The system 10 (FIG. 1) allows the precise control of movement (e.g., the rate, distance and/or direction that the subject travels in response to the visual stimuli). Movement can be prompted over varying distances and directions to modulate the intensity of the exercise, for example to avoid reinjury by attempting overly intense exercise. Thus the resulting rehabilitation can follow a scripted, return-to-play exercise program for concussion that is based on the Zurich “Graduated Return to Play Protocol.” Measurements during exercise can be invaluable for controlling the progression rate. Such measurements are compared to baseline (pre-injury) tests and/or to normative ranges. By using realtime measurements of fundamental performance and physiological factors, coupled with an interactive training environment, the system advantageously improves on current methods for Zurich Protocols that include rehabilitation stages progressing from light aerobic exercise to sport-specific (task-specific) exercise to non-contact training drills.

Some movement constructs have been discussed above in connection with cognitive or neurological testing and/or rehabilitation. A wide variety of other measurements or constructs may be utilized alternatively or in combination, including a measure of work performed by the player, a measure of the player's velocity, a measure of the player's power, a measure of the player's ability to maximize spatial differences over time between the player and a virtual protagonist, a time in compliance, a measure of the player's acceleration, a measure of the player's ability to rapidly change direction of movement, a measure of dynamic reaction time, a measure of elapsed time from presentation of a cue to the player's initial movement in response to the cue, a measure of direction of the initial movement relative to a desired response direction, a measure of cutting ability, a measure of phase lag time, a measure of first step quickness, a measure of jumping or bounding, a measure of cardio-respiratory status, and a measure of sports posture. Data can be obtained with regard to any or all of these parameters, as well as many others, and stored and evaluated in any of a variety of suitable ways, using any of a variety of suitable methods.

The system is described in terms of cognitive testing and evaluation in terms of brain injuries, for example concussions. Alternatively the system may be used for evaluation of other cognitive conditions, for example neurological diseases.

Another way that fitness can be assessed involves measuring subject response while the subject is put through a regimen of exercising that includes increasing exercise intensity. Using systems such as those described herein, a subject may have his or her response during such exercise of increasing intensity measured. The response may include measurement of heart rate, measurement of reaction time, and/or measurement of other parameters, such as work rate. The response as a function of exercise intensity may be examined, for example by plotting exercise intensity versus time, and one or more measured responses versus time. Results may be compared with previous results from similar regimens, for example to assess the fitness of a subject by comparing to a baseline state, for example to determine if a return to a pre-injury state has been achieved.

Fitness assessment can be performed using a system such as described elsewhere herein. A subject may be put through a regimen that includes a controlled progression of exercise intensity. The control of intensity may be based on a measure of work rate, for example based on metabolic equivalents (METs). A MET is a standard metabolic measure that refers to the amount of oxygen used by the body. One MET has been defined as a level at which the body uses 3.5 ml oxygen/minute/kilogram of body weight, and is about the amount of oxygen required by the body to just sit. METs allow exercise capacity to be standardized, so that a given physical performance on an cardiac exercise test indicates a certain level of fitness. About 5 METs are required to do very light work. People who do not exercise regularly and lead a very sedentary lifestyle often can't do more than about 7 METs on an exercise test. Healthy people who get regular exercise can reach higher MET levels. It will be appreciated that METs are just one or many levels by which exercise intensity can be determined. The result is an interactive movement simulator evaluation that prompts three-dimensional movement responses from the subject to provide an assessment of functional cardiorespiratory and kinetic (“movement”) performance, fitness, and health.

It should be stressed that the control of exercise intensity is not based on heart rate. Rather heart rate is measured and compared (directly or indirectly) against exercise intensity. Changes in heart rate versus exercise intensity, for similar exercise regimens run at different times may be an indication of changes in condition of the subject. For instance, comparing a post-injury assessment versus a baseline assessment may allow determination of whether a subject has recovered from an injury. For an injured person, such as an athlete that has received a head injury, the change of heart rate versus exercise intensity may different than when the person is in good condition. An exercise intensity at which heart rate sharply increases may be altered when the subject is suffering from a cognitive injury.

The assessment may precisely control the progression of the exercise intensity delivered to the subject. For example this progression may range from the subject standing at rest at a “start position,” all the way until the subject achieves his or her “volitional maximum,” a level of exercise at which the subject cannot continue. The maximum exercise level used may depend upon the subject population. For example, elite athletes may be tested up to a volitional maximum, but such testing may be inappropriate for subjects at risk for an injury at high levels of activity. The assessment can be terminated based on a number of factors, such as volitional exhaustion, achievement of a fraction of the subject's predicted maximum heart rate (such as 85% of the predicted maximum heart rate), a measure of degraded subject performance of the cued activities, and/or the emergence of any of a variety of symptoms in the subject, such as physical symptoms.

The control of exercise intensity is not based on heart rate, but may be based rather on a measure of “work rate” expressed as METs derived from knowledge of the subject's mass and realtime moment-to-moment positional changes in response to the system's interactive cueing. This controlling (modulating) of the progression from low to high exercise intensity provides a controlled profile of work rate versus time, in which certain other key variables can be compared/evaluated. The exercise intensity progression can be repeated for different assessments accomplished at different times. This graded progression of exercise intensity is analogous to that of Bruce/Balke cardiac stress tests (performed on treadmills or other stationary exercise equipment), with one major exception. The planned, one-dimensional (stationary) exercise pattern of a treadmill or stationary bike, where the subject walks/runs in place as the belt speed and angle are progressively increased, is replaced by interactive, three-dimensional movement.

The three-dimensional movement may more closely resemble situational performance, analogous to a situation for which the subject's fitness is being evaluated. Just one result is that this game-like (or other situation-specific) challenge introduces situational performance stress (decision-making). It is known that cardiac demand is impacted by situational performance stress and attention demands. By simulating a situation (like a sports situation) more closely, the function of subject in the relevant situation is more accurately determined.

The assessment's graded exercise protocol allows collection of many more performance samples (measurements) of fundamental components of movement for improved accuracy. The objective is to collect as many valid reaction time (as well as other performance measures such as acceleration, velocity, etc.) samples as possible to improve test accuracy. Movement challenges (cued subject movements) may be modulated/controlled in order to progress the subject's work rate. The protocol/system/method have the ability to scale the movement challenges so the subject always makes a reasonable/maximal effort but the scaling is such that during the initial stages of the test, the distance to be travel is sufficiently short to ensure the work rate (exercise intensity) is properly controlled/modulated. The movement challenges may be easy in the early stages, with later stages providing more challenge. This may be accomplished by having a multiplicity of virtual targets (cued movements) of varying distances and directions so that the challenges can be properly modulated/scaled. For example, the closest movement targets to the subject may only be a foot or so from the subject's start position, while the further targets may be 10 feet or more as the intensity is increased.

At the beginning of the test, the subject may be prompted to move over these short distances with relatively infrequent presentation of cues. The system may then proceed to increase the exercise intensity by increasing the distances traveled as well as the frequency of movements. This variability will naturally provide more samples in which to extract performance data. The work rate (exercise intensity) may be increased at a substantially constant rate relative to time, with heart rate and reaction time being examined as time changes to determine how they are related to work rate.

Energy and work may be measured either in the system 10 or using data generated by the system 10. The energy expended by an individual in the inventive system can be derived from work. The mechanical work is calculated by multiplying the force acting on an individual by the distances that the individual moves while under the action of force. The expression for work (W) is given by

W=F*d.

The unit of work is a joule, which is equivalent to a newton-meter.

Power P is the rate of work production and is given by the following formula

P=W/T

The standard unit for power is the watt and it represents one joule of work produced per second.

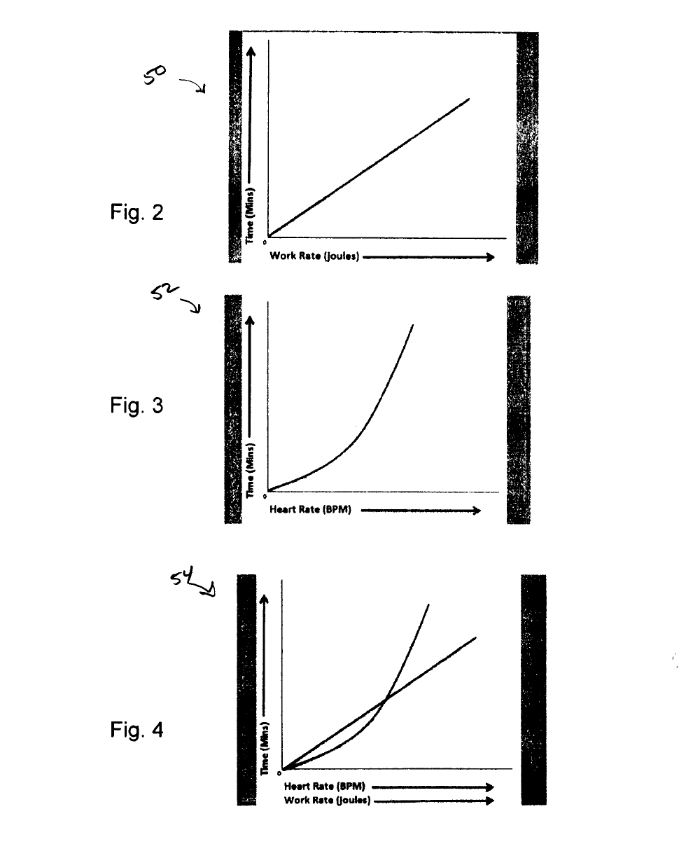

One way of presenting and evaluating the results of an assessment is illustrated in FIGS. 2-4. Each of the relevant variables may be graphed in a manner to provide clear visual feedback to the administrator relating to, but not limited to, the relationship of the slope and intercept points of each variable with the constantly increasing exercise intensity over time. Work as the constantly-increasing factor facilitates the development of normative data, such data was developed for the existing treadmill tests.

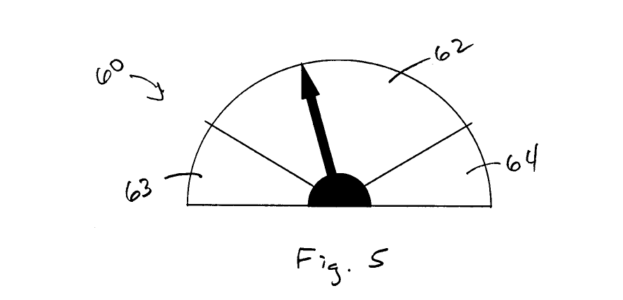

FIG. 2 shows a plot 50 of work rate versus time for an example assessment. FIG. 3 is a plot 52 of heart rate versus time for the assessment. FIG. 4 shows a plot 54 with the two plots overlaid. The scales for the overlaying are somewhat arbitrary, but comparing the results from multiple assessments, plotted the same way, may provide useful information in assessing a subject. For example the relative slopes and any inception points of these two lines may provide information regarding the subject's heart rate at each work rate while executing functional movement. For example, if the heart rate at a given work rate is exaggerated (too high early in the progression or assessment), it will be quickly evident to a reviewer of the test results.

Reaction time may also be overlaid to provide information regarding how is the subject's reaction time affected at each work rate. For example, examination of the work rate where reaction time degrades may provide useful in an evaluation. Other measurements of subject performance may be treated similarly. Examples of other measurements that may be of importance are speed of subject motion (e.g., average speed) and acceleration (e.g., average acceleration).

It will be appreciated that what is shown in FIGS. 2-4 is only one way of presenting the data. Many other measures and methods of presentation are possible. The data may be used to present a wide variety of quantitative and/or qualitative parameters to aid in assessing performance.

The assessment protocol may be carried out by directing the subject to a start position, with the subject's heart rate continuously monitored during the assessment, such as by telemetry. The subject may be directed to make controlled movements, which may involvement movements in three dimensions, along with changes in posture and/or orientation. The movements may be varied over time to increase the exercise intensity. For instance the distances traveled and frequency of movement cues may be gradually increased, such as by being increased in stages. Reaction time (and/or other movement parameters) may be recorded throughout all or part of the assessment. The subject is exercised under increasing intensity until a point is reached for ceasing the exercising. This may be when the subject achieves a predetermined heart rate (e.g., a predetermined fraction of a predicted maximum heart rate of the subject), or may involve any of the other triggers or other conditions discussed above.

In addition, after termination of the exercising part of the assessment, the subject may be instructed to remain still, for example by sitting or laying down, while heart rate continues to be measured. This may be done for a suitable time period, for example for two minutes. The degradation of heart rate after exercise may also be used in evaluating the fitness of the subject.

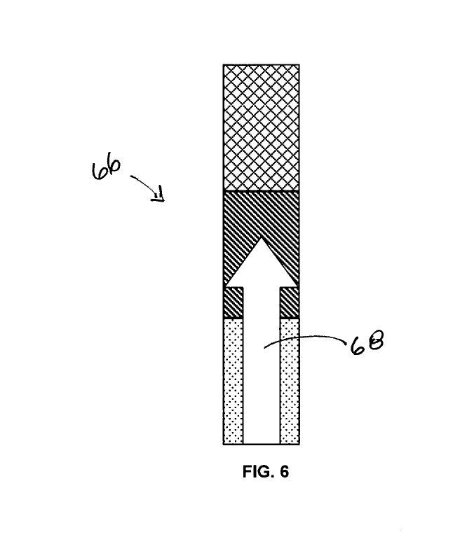

FIGS. 5 and 6 show two mechanisms that may be used to give a test subject feedback regarding work rate or work load of the exercise that the subject is engaged in. In cardiac exercise (stress) tests employing a treadmill control (increase the work rate) the load is imposed on the subject by increasing the speed of the treadmill platform and/or the incline of the platform. With each increase in load, the subject needs sufficient exercise capability to assume and maintain the new work rate (load) or the test is terminated. This approach can be characterized as externally imposing the load on the subject so as to test his tolerance for exercise.

However, in contrast to the aforementioned externally-imposed load cardiac exercise tests, the testing described earlier herein relies on the subject's “volitional control,” the subject's compliance with the prescribed work rate (the pace of the test protocol). To maintain the current pacing (work rate), it is advantageous that the subject be provided with essentially real time feedback regarding his or her performance. The feedback can be, for example, in (and/or based on) METs, calories, speed or similar metrics related to work rate. Such feedback informs subjects whether they are moving too fast or too slow.

FIG. 5 shows one example of a work rate meter that is analogous to a speedometer on a car dashboard, and that provides feedback to a test subject regarding work rate. In this example, the subject is akin to the driver, and strives to maintain her speed within a range consistent with the speed limit. The meter 60 shown in FIG. 5 is in the form of a semicircle or other portion of a circle or an annular area, with a moving needle that moves to indicate changes in work rate. The meter 60 may have different regions, for example having a central region 62 corresponding to a target work rate that the subject is supposed to maintain, bounded on opposite sides by a region 63 where the subject's work rate is below the target (prompting the subject to increase work rate), and a region 64 where the subject's work rate is too high (prompting the subject to decrease work rate. The regions may be provided with colors and/or textual markers, providing information to the test subject. The meter may have visual effects when the subject's work rate is outside of the desired target zone, for example flashing when the work rate is too high or too low, to act as an alert to the subject.

The form of the work rate meter shown in FIG. 5 is only one example of the many forms that such a meter may take. FIG. 6 shows another example of a work rate meter. The FIG. 6 work rate meter 66 is a bar, with the length of an arrow or other marker 68 corresponding to work rate.

The analog or a digital meter or work rate may be provided on any of a variety of displays or other visual devices. For example the meter may be a part of a display or other visual device that provides real time guidance to subjects regarding their compliance with the prescribed movement rate for each given stage of the test.

### Training Cycle

One could speculate that nearly all persons who exercise, either by design or unconsciously, apply the principles of the training cycle, i.e.: the ongoing cycles of stress (exercise), breakdown, recovery and super-compensation. If successfully adhered to and managed, the result is an improvement in performance-fitness. Inappropriate stress (exercise) and/or sufficient recovery and the result can often be performance degradation, overreaching, overtraining, etc.

The use of exercise prescriptions is core to numerous professions that include those delivering performance enhancement, health and fitness training, rehabilitation and occupational health and safety. The objective of such exercise prescriptions is to improve or restore the performance (functional) capabilities to levels consistent with one's personal health, fitness/performance goals.

It is well recognized that there is a delicate balance between the delivery of appropriate training intensity and sufficient recovery. It is especially challenging absent measurement tools capable of identifying where the client/patient/athlete is along the training cycle.

Periodization has been defined as the systematic planning of athletic or physical training. It involves progressive cycling of various aspects of a training program during a specific period. It is a way of alternating training to its peak during season. With regard to sports periodization, periodic training systems typically divide time up into three types of cycles: microcycle, mesocycle, and macrocycle. The microcycle is generally up to 7 days. The mesocycle may be anywhere from 2 weeks to a few months, but is typically a month. A macrocycle refers to the overall training period, usually representing a year or two.

The roots of periodization come from Hans Selye's model, known as the General adaptation syndrome (GAS), describing biological responses to stress. The GAS describes three basic stages of response to stress: (a) the Alarm stage, involving the initial shock of the stimulus on the system, (b) the Resistance stage, involving the adaptation to the stimulus by the system, and (c) the Exhaustion stage, in that repairs are inadequate, and a decrease in system function results. The foundation of periodic training is keeping one's body in the resistance stage without ever going into the exhaustion stage. By adhering to cyclic training the body is given adequate time to recover from significant stress before additional training is undertaken.

The response to a new stress is to first respond poorly and the response drops off. For example when the body is first exposed to sun, a sunburn might develop. During the resistance stage adaptation improves the response to a higher level, called super compensation, than the previous equilibrium. The goal in sports periodization is to reduce the stress at the point where the resistance stage ends so the body has time to recover. In this way the exhaustion stage does not reduce the gains achieved; the body can recover and remain above the original equilibrium point. The next cycle of increased stimulus now improves the response further and the equilibrium point continues to rise after each cycle. The challenge is balancing the basic elements of training program design—intensity, volume, and periodization. What must always be considered is the inter-individual variability of one's response to exercise.

Use of the system 10 and the method described can facilitate with training program design and subsequent program monitoring/management. The system 10 can provide information valuable for optimizing and personalizing training programs for each individual by measuring certain fundamental components/aspects of the training cycle. It can measure both the positive and negative outcomes of training programs. The result is evidence-based exercise prescriptions where each individual program can be optimized based on data systematically measured; replacing in many cases the trial-and-error adjustments normally associated with current approaches.

Using the system 10, the subject's performance capabilities using a graded (or repeated) test of both cardiorespiratory and movement performance. This measurement is used to estimate the subject's “system-wide” recovery from previous exercise sessions, to measure the global (cumulative) effects of previous training sessions. To that end, the results from similar tests at different times may be compared, even where the tests are not graded tests.

It acts to characterize the subject's response to previous exercise doses. In essence, the system 10 has the unique ability to measure fundamental components of performance that vary based on the training program. For example, it can detect the initial decrease in performance following an increase in the training load, which may in some instances, be associated with overreaching and/or overtraining. In doing so, the system 10 uniquely enables unprecedented levels of customization relating to certain fundamental aspects of training: overload, breakdown, recovery and supercompensation. The system 10 provides means of quantitatively determining the effects of training load, intensity and duration of each training session.

An example of a graded testing protocol is an interactive, sport-specific test that simulates (replicates) the global challenges of actual reaction-based sports and other functional movement capabilities required in an active lifestyle. The measurement during such situational-specific movements is believed to have more value than tests limited to measuring isolated capacities.

The graded testing protocol may also have a low PER (Perceived Exertion Rating), which helps to ensure compliance with the testing protocol. This is useful, as a higher frequency of testing is important to maximize the value of the data collected. The greater the test frequency, the greater the number of data points available to define the subject's actual (real) Training Curve. More data points enhance the value of the data.

Defining the training curve based on real data serves to determine if appropriate levels of stress are being applied and whether sufficient rest is being afforded. It also recognizes that the training cycle is comprised of an agglomeration of training sessions, all potentially contributing to the overload and recovery process. Numerous data points may be required to define the training cycle “precisely.” And the use of the system 10 increases subject motivation. The test protocol's low PER, and what may be perceived as a game-like format, acts to make the test entertaining for most, and therefore may encourage its more frequent use. Results from serial tests can serve as a basis to “draw” (i.e. “plot”) the subject's actual stress-breakdown-recovery-super compensation curve. (“stress-adaptation” model)

As serial (numerous) testing post the baseline test is advised/beneficial, it is helpful for the testing to be sufficiently compelling (have a low PER) to ensure compliance. The testing is preferentially also relatively brief so that it can be integrated into most training programs, as generally training time is most valued/limited. By precisely measuring/monitoring the athlete's (or other subject's) response to each training session, the trainer, coach and/or clinician has the information to perhaps avoid the short and long-term effects of insufficient recovery. And the quantification of the training cycle enables training optimization.

The ongoing cycle of training, breakdown and recovery may be compared to a roller coaster ride. To date, there is no practical means for measuring a subject's whole body (global) response to exercise, whether that subject be an athlete, a fitness participant, a patient, a tactical operator, someone in safety services, or another human. If the whole body response to exercise is not known, effectively personalizing a training program to optimize results while minimizing the risk of burnout and injury would be difficult.

In essence, the system 10, using repeated testing with the same (or similar) protocols, provides the data points based on actual measurement of subject's current whole body (global) performance to “define” the subject's status based on the subject's actual measurements relating to aspects of their whole-body recovery. The results of each and every test can be automatically plotted on a report viewable by the test administrator, subject, etc.

One important application of the present invention is for occasional testing (assessment) of a subject who may be involved in, or contemplating an exercise program. “Occasional” means in the context of this application, one or more assessments that are administrated sporadically and/or incidentally. Such sporadic or occasional testing can have significant value; for example, as a preseason physical, etc. The testing also has significant merit for defining (plotting actual results of individual or serial tests on a viewable report) the subject's actual training cycle based on actual measurement of his/her status based on periodic testing.

Athletes can react, accelerate, and cut in response to unpredictable game play. It is estimated that 80% of the information relied on during competition is visual. With athletes relying primarily on visual information, preplanned tests say nothing about the athlete's ability to respond to what they see or how adeptly they mobilize into action. Tests that measure the elapsed time to run a preplanned course generate no meaningful data regarding a plethora of key sport-specific markers that include the athlete's sensory and cognitive status. By combining real time 3D position tracking with telemetry heart rate measurement, the system 10 may uniquely assesses the athlete's global performance capabilities. The model for the athlete holds true for most of us in our daily lives; we react and move to what we see in the workplace, at home and at play.

Measuring an athlete's global response to training (exercise) allows characterization of the athlete's “recovery status”, i.e. their degree of recovery from previous training sessions. This is useful data for prescribing optimal doses of exercise for each and every training session, and it can be used to detect early signs of overtraining that can lead to burnout, increased risk of injury and even a shortened season.

As stated above, the testing may be a graded exercise test of both sport-specific cardiorespiratory and movement performance. In a “graded” test, work rate demands may be safely and precisely increased similar to the graded cardiac exercise tests used by cardiologists. However, unlike cardiac exercise tests, testing using the system 10 substitutes sport-specific, reaction-based three-dimensional weight-bearing movement for the treadmill's monotonous and repetitive movement. This may ratchet up the realism, and therefore its relevance to actual game play. To measure the previously immeasurable aspects of movement to characterize both cardiorespiratory and kinetic (movement) performance fitness.

As a “sports simulator”, the system 10 challenges the athlete's/subject's visual, cognitive, neuromuscular and metabolic systems by prompting sport-specific (“real world”) movement responses that act to elevate the athlete's heart rate to game levels. The testing may be incorporated into a training regimen, for example occurring as the perfect start to a training session: interactive, game-like, with the lowest perceived exertion rating (PER) of any testing or training device we are aware of. Challenging athletes/subjects in this manner enables personal trainers, coaches, physical therapists (PTs), etc. to fine tune the delicate balance between proper training intensity and sufficient recovery.

The system 10′s continuous measurement of heart rate and movement speed is used to characterize the athlete's work capacity and can be compared to baseline assessments. The athlete's reaction time to unplanned visual cues provides a measure of the athlete's cognitive prowess during the rigors of game play. This is objective data that uniquely correlates with whole body status.

By way of example, a test might indicate an average movement velocity of 6.2 ft/sec, a peak heart rate of 185 bpm and an average reaction time of 0.7 seconds, with the athlete at 22 METs at volitional termination. Software of the system 10 may automatically compare these results to those of previous tests.

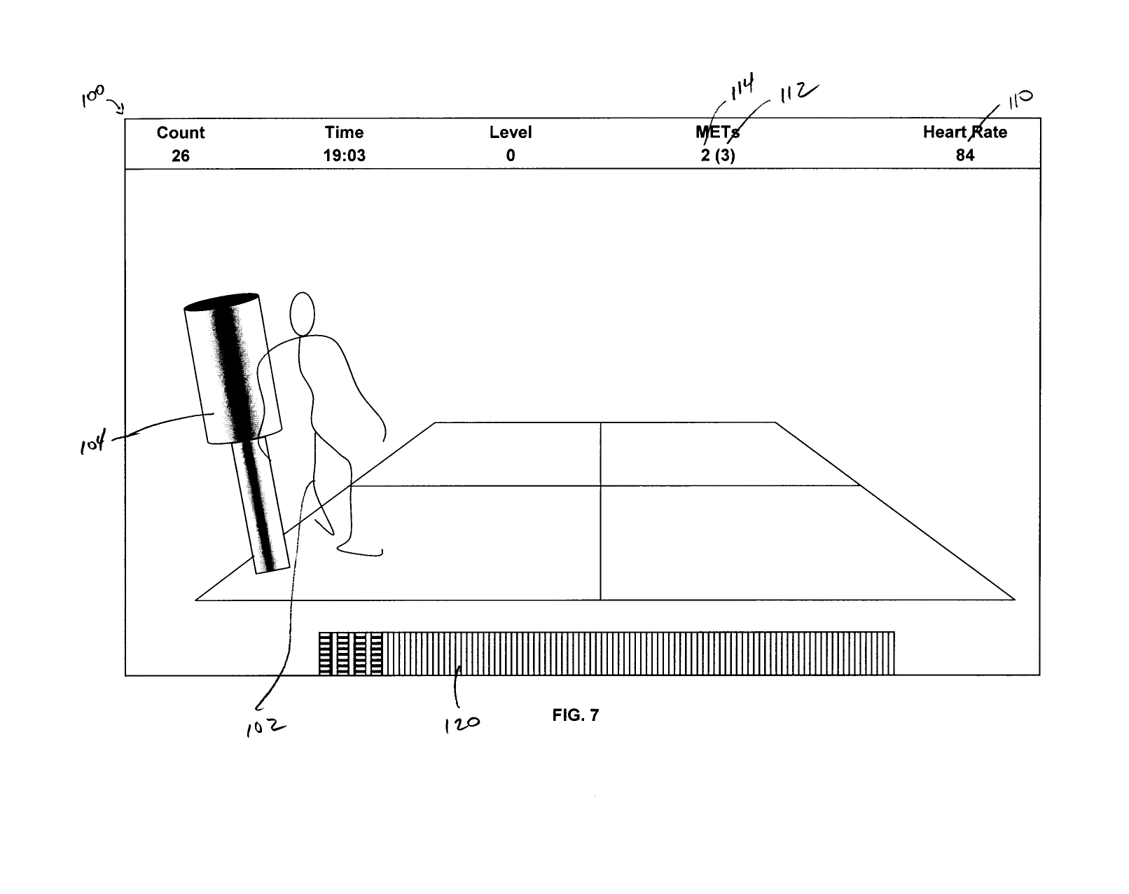

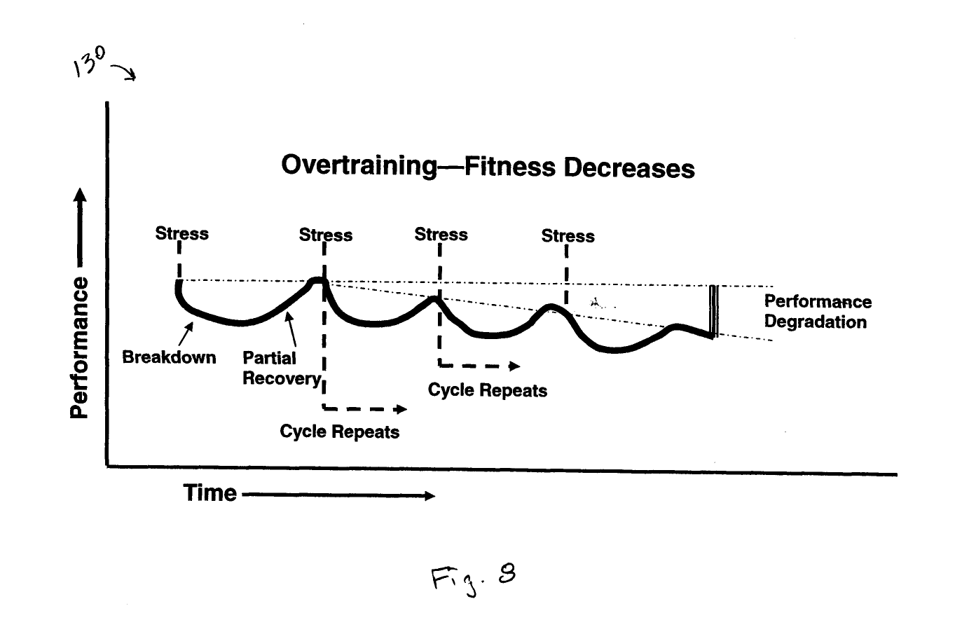

FIG. 7 shows a screen 100 that may be shown on a display such as the display 26 of the system 10, to provide cues for movement of a test subject, and to provide feedback to the test subject to maintain exercise intensity at a desired level. In one example activity, the subject may be cued to move, translating his or her body to position an avatar 102 (corresponding to the subject) at the location of a virtual object 104. The object 104 is then repositioned to cue the subject to move again. The distance that the virtual object 104 is repositioned may be selected to control the distance of movement increments demanded of the test subject. In addition, exercise intensity may also be controlled by encouraging the subject to move at a limited speed, rather than moving so as to position the avatar 102 at the virtual object 104 as quickly as possible. This may be done by providing feedback on the screen 100, as described below.

During the test, the subject's Heart Rate is displayed at 110 in real time. Current and target work rates (in METs) are displayed in both analog and digital formats. The target work rate is in parentheses at the top of the screen 100, at 112. To its left, at 114, is the rolling 30-second METs average, a measure of the current work rate. The user is encouraged to keep these numbers as close as possible, with the displayed work rates providing feedback to keep the exercise intensity at a desired level.

A segmented bar 120 at the bottom of the screen 100 provides analog feedback of the subject's compliance with each Stage's Work Rate. In one example embodiment, when the subject is moving at the prescribed rate, the segments light in green. Red signifies the movement rate is too fast. Blue indicates that the current movement rate (which may be averaged over some time span) is too slow. The number of segments may corresponds with the number of METs that are desired for that stage of the test, or with some other measure of exercise intensity.

The visual/cognitive demands on the subject in using the screen 100 are perhaps analogous to driving a car, where the driver monitors both traffic conditions and the car's speedometer. It has been found that engaging the subject in this manner reduces the perceived exertion rate (PER) in performing the test.

The test described above delivers an effective computer-controlled test that may be used as a warm-up activity, and that progressively challenges the athlete's sensory, cognitive, neuromuscular systems. It elicits sport-specific, reaction-based movement that stimulates the nervous system and improves motor abilities. Gradually and precisely, via the computer-controlled pacing, the athlete or other subject responds to visual cues/stimuli, starts, decelerates, changes direction and re-accelerates, which progressively challenges body control.

It is preferable that the test/assessment of the present invention require a relatively brief number of minutes to complete. For example, less than 20 minutes or so is believed preferable, and in the range of 3-8 minutes may be most suitable for the numerous populations to be tested. The information obtained from the test may be used for (without limitation):
Screening for early signs of overtraining.
Detecting movement deficits to improve performance and reduce the risk of sports injuries.
Ensuring satisfactory return from injury.
Fine tuning performance enhancement programs.
Determining a subject's tolerance to training.
Personalizing training programs according to each subject's tolerance.
Ensuring compliance with off season training programs. Compare actual subject status vs. projected performance.

Unlike the results of many other tests, the testing described provides direct, reliable data that accurately characterizes real-world performance. This is information that is directly transferable to daily activities involving movement.

The subject's heart rate is continuously monitored via telemetry. Reaction Time, Acceleration, Velocity, Deceleration and Distance Traveled are continuously measured and reported by movement- direction. Visual cues guide the athlete (or other test subject) through a precisely controlled progression of exercise intensity. The test may be a graded exercise test, which by definition, progressively increases physiological demand on the subject. During the early stages of the test, demands are limited on the subject, and are progressed to intensities appropriate for the subject. In some populations cleared for strenuous exercise by a physician, a “maximal effort” improves the accuracy and reliability of the test protocol.

Typically, the intensity ranges from the athlete standing at rest and positioned at a “start position” until such moment in time that the athlete elects to quit due to fatigue, i.e. the subject achieves “volitional maximum.”

For valid testing, the subject should be familiar with the Test format and have adequate physical conditioning to safely perform at the levels appropriate for the subject. The graded nature of the test allows the subject to become familiar with the cues, their placement, and the spatial relationship between the virtual world and the real world before the intensity is increased. Depending on the subject being tested, ranging from “at risk” populations (for example with medical clearance to participate) to elite athletes, the testing can be terminated based on several factors, which may include one or more of:
Volitional Exhaustion (as above).
% of maximum HR, such as 60%-85% of the client's predicted maximum for their age.
degradation of physical performance (such as movement rate).

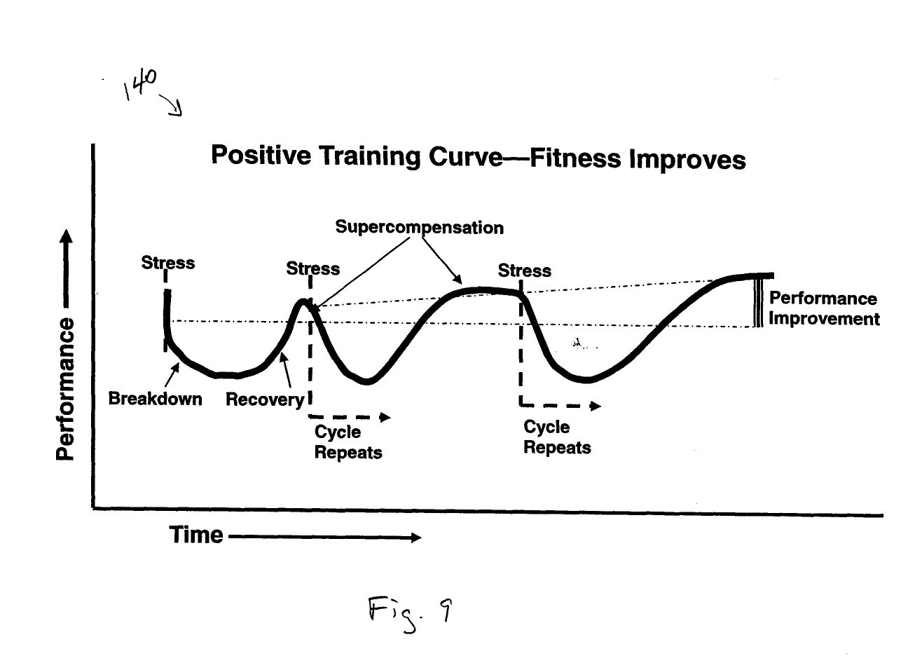

FIG. 8 is a graph 130 showing a (representative) training cycle for a training program that has resulted in performance degradation for the subject. This graph suggests that perhaps the subject is in an overreaching state. Insufficient recovery was allowed before the application of additional stress (exercise).

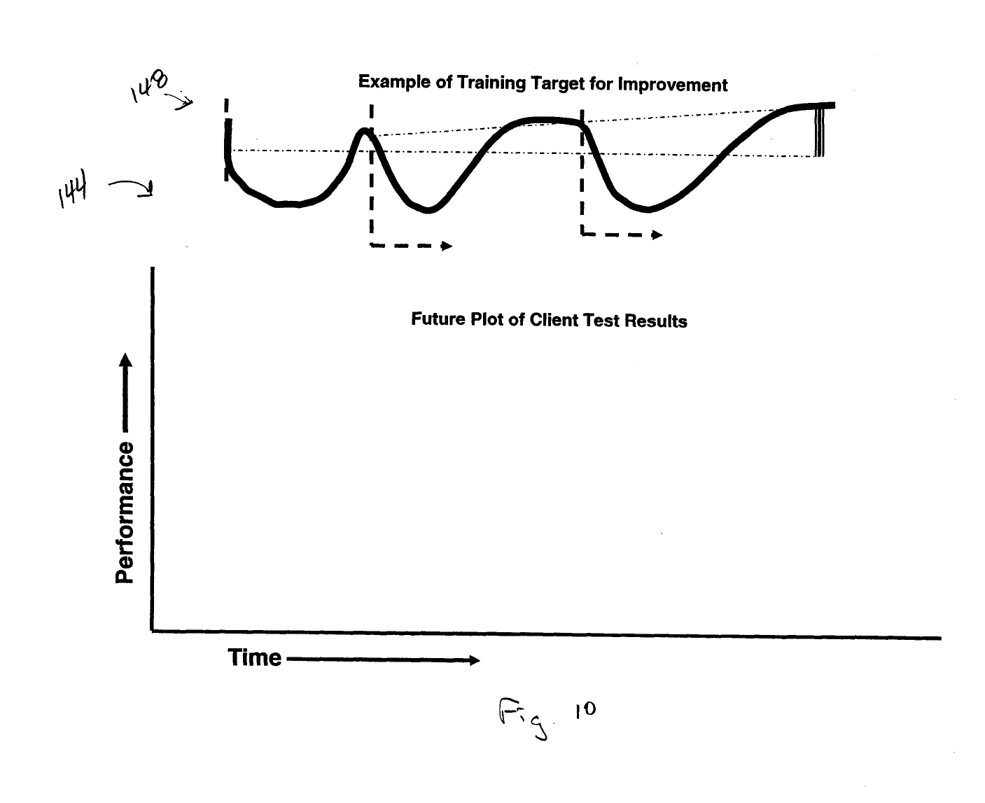

FIG. 9 is a graph 140 showing a (representative) training cycle that results in performance improvement. Sufficient recovery time was allowed before the application of additional stress. The result of the training cycle depicted was “supercompensation,” and ultimately a gain in performance capacity.

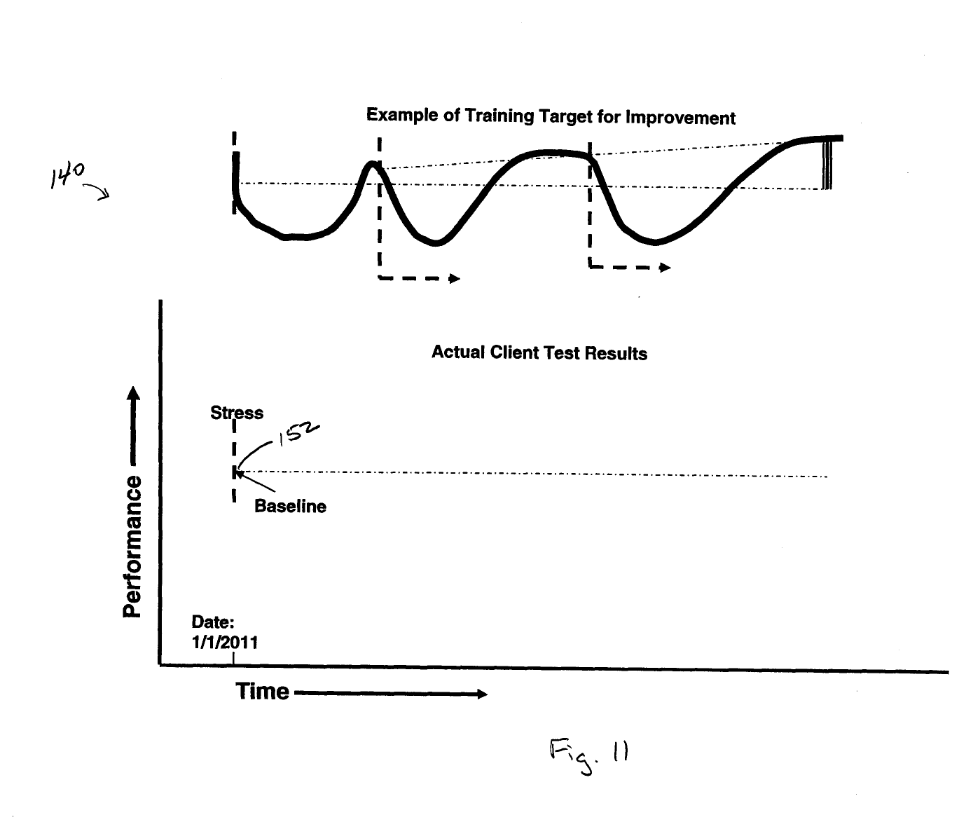

FIG. 10 shows an example report screen 144 for the present invention. At the top of the page is depicted a desirable template/representative training cycle 148 to serve as an example for the subject and the test administrator. The “empty” (unpopulated) graph below will depict the subject's actual training cycle in serial fashion as each test is completed and plotted on the report. The Time Line (x axis) will note the date of each test; the Performance Line (y axis) will record the METs achieved.

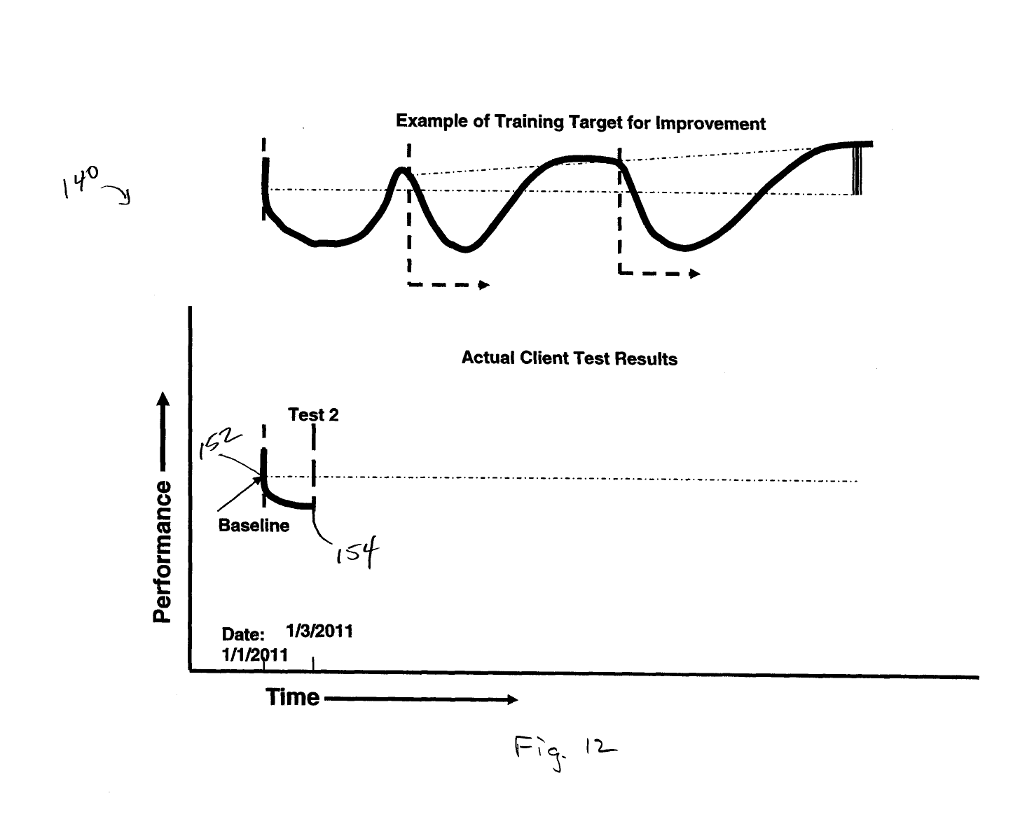

FIGS. 11-14 shows successive report screens 140 as a graph is constructed point by point over time, as tests occur one by one over a series of days. The graphs show performance versus time, with time corresponding to the day on which a test is run. Performance may be any of a variety of constructs that corresponds to global performance during the tests described above, such as a graded test. One example of a measure of performance is the METs achieved at peak heart rate, or at a given predetermined heart rate (absolute heart rate or heart rate that is a percentage of peak heart rate). Another example of performance is a measure related to heart rate at a given level of METs. A further example is the maximum METs achieved before termination of the test, with termination for example controlling using one or more of the above termination criteria.

FIG. 11 depicts the first actual data point 152 generated by the subject's baseline test. This initial test establishes the subject's baseline on which the cycle builds.

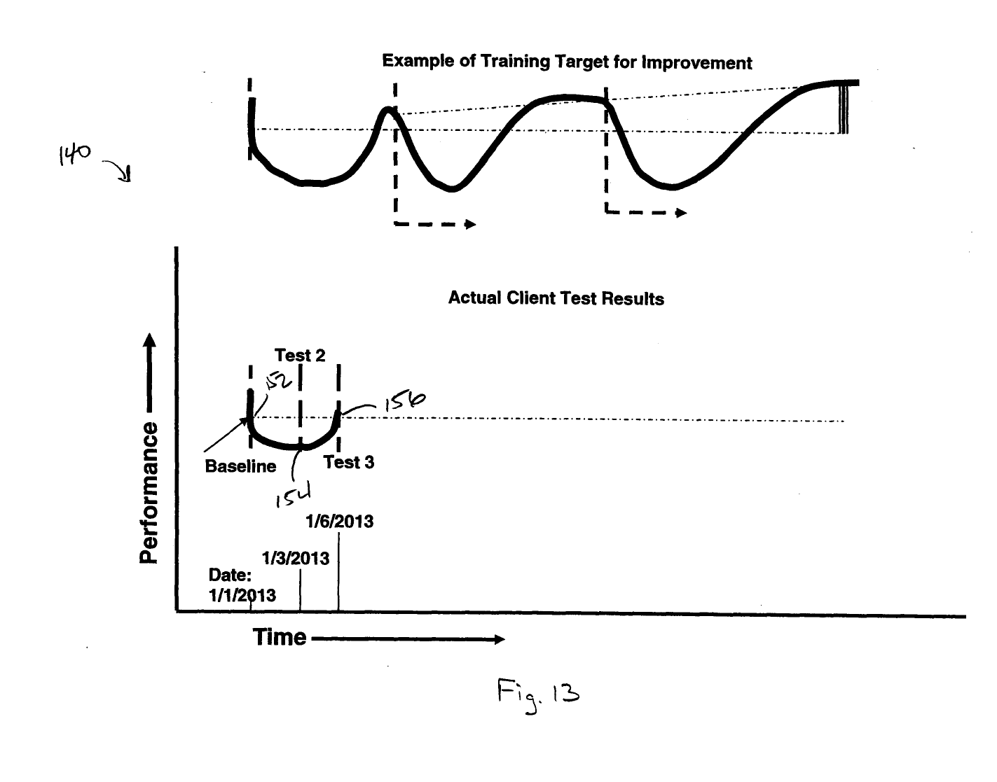

FIG. 12 depicts the addition of the second actual data point 154 generated during the first training session (application of stress) post the baseline test. It illustrates that the subject is in the “breakdown” phase.

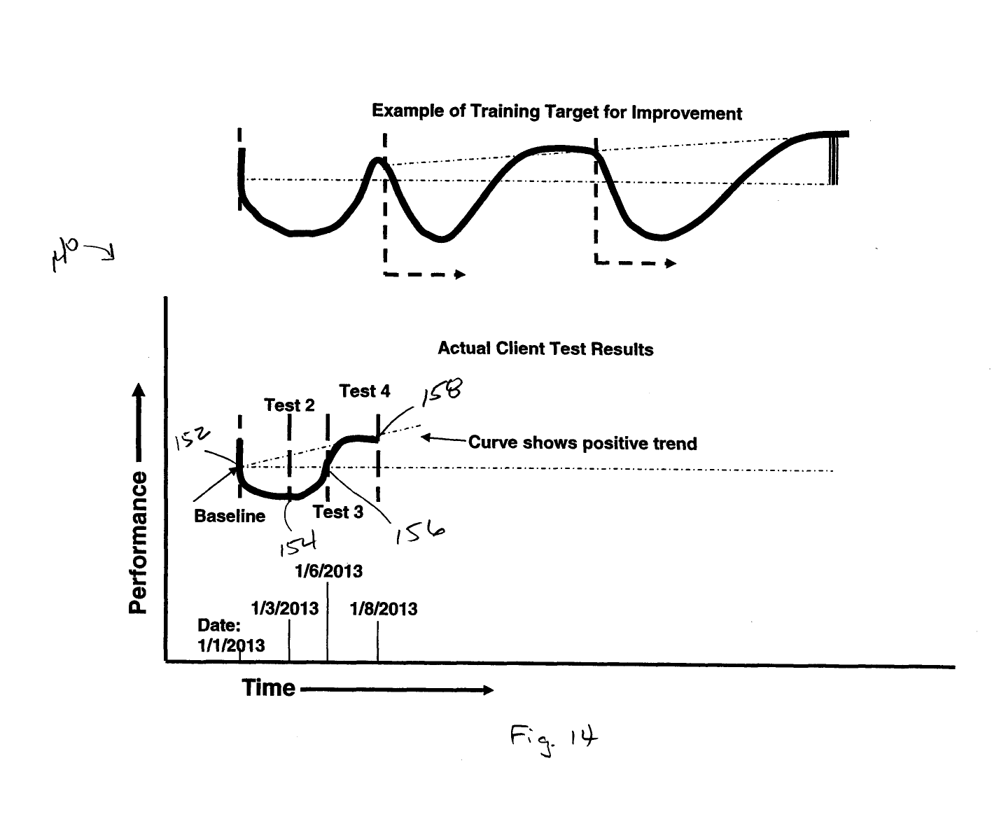

FIG. 13 depicts the third actual data point 156 generated during the second training session (application of stress) post the baseline test. It illustrates that the subject has recovered (i.e. returned to baseline).

FIG. 14 depicts the fourth actual data point 158 generated during the third training session post the baseline test. It illustrates that the subject is in the super-compensation phase. If, instead, the line had dipped immediately below the baseline, the administrator would know that the recovery phase had not been complete, and the stress level would be backed off to avoid overtraining, which at its essence is an imbalance in the stress and regeneration phases of training/conditioning.

Overtraining can be determined by examining the trend of many graph points over time. A reduction of performance peaks indicates that overtraining may be occurring, perhaps indicating a need for reducing workout intensity in order to prevent further degradations in performance or fitness.

By using simulation to measure an athlete's global (whole body) recovery during critical stages of training, one can know whether the athlete's training is on the track. Immediately actionable information can be used to detect insufficient recovery. This can allow optimization of each athlete's programs to improve results and reduce the risk of breakdown, or other effects of overreaching or overtraining syndrome (OTS).

OTS alludes to the fact that overtrained subjects appear to suffer from symptoms referable to disruptions in multiple physiologic systems, resulting in a diminution of overall physical performance. In addition, possible decrements in cognition (reaction time), kinetic (movement) and cardiorespiratory systems have been shown to be negatively affected by OTS. Also, it is well accepted that movement defines functional capability. Measurement of the fundamental components of movement allows the clinician, trainer or coach to view overtraining as a continuum of the capacity for movement.

Some of the advantages of the testing as described above include: 1) the ability to elevate the subject's metabolic rate, as measured by heart rate, to levels consistent with game play/active daily challenges with low perceived exertion (PER); 2) the measurement of the subject's reaction time to spontaneous (unplanned) stimuli that prompt sport-relevant/functional movement responses as well as heartrate response, which are defined as multi-vector (3-dimensional) movement comprising distances approximating those of game play; and 3) the measurement of key components of movement that include reaction time, acceleration, velocity, deceleration, jump height, etc.

A system (and method) configured to optimize training programs to improve performance-fitness as well as reduce the incidence of overreaching/overtraining, can benefit from the detection of a subject's universal (global) loss of the capacity for movement. Of course, having the ability to detect asymmetric movement patterns may serve to identify orthopedic issues that can negatively affect global performance. Such asymmetrical movement patterns may, for example, be the result of deterring pain, lack of confidence and/or proprioception in the injured limb as the subject attempts to accelerate off said limb. Both reaction time and acceleration specific to this vector may be diminished. The approach described herein may improve test sensitivity by the generation of movement-specific performance data to detect an “isolated” orthopedic deficit. Testing for symmetry of movement deficits could be performed for both baseline and during and post the physical training process. This knowledge would assist the test administrator in determining if any extraneous causes for diminishing global performance exist.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A method of assessing a subject, the method comprising:
directing the subject to exercise by providing movement cues for whole-body movement, wherein the directing includes providing feedback to the subject during the directing, for the subject to maintain compliance with a desired exercise intensity;
measuring subject response to the exercise; and
evaluating the measured subject response.

2. The method of claim 1, wherein the directing includes increasing exercise intensity over time.

3. The method of claim 2, wherein the increasing exercise intensity is a graded increase of exercise intensity.

4. The method of claim 2, wherein the increasing exercise intensity includes increasing distance of directed movements and rate of directed movements.

5. The method of claim 1, wherein the directing includes directing movements of controlled distance.

6. The method of claim 5, wherein the directing also includes providing feedback related to speed of the subject's movement.

7. The method of claim 1, wherein the providing feedback includes providing visual feedback.

8. The method of claim 7, wherein the providing visual feedback includes providing the visual feedback using a display that is also used in the prompting.

9. The method of claim 7, wherein the providing visual feedback includes providing visual feedback on work rate of the subject during the directing.

10. The method of claim 1, wherein the measuring includes measuring heart rate.

11. The method of claim 1, wherein the measuring includes measuring work rate.

12. The method of claim 1, wherein the measuring includes tracking body position of the subject during the directing.

13. The method of claim 12, wherein the tracking includes tracking using a camera.

14. The method of claim 1, wherein the measuring includes measuring one or more movement parameters, with the one or more movement parameters including reaction time.

15. The method of claim 1, wherein the evaluating includes comparing work rate and/or heart rate determined from the measuring subject response, with results from an earlier assessment.

16. The method of claim 15, wherein the earlier assessment is a baseline or uninjured assessment.

17. The method of claim 15, wherein the evaluating includes comparing changes in one or more of work rate versus time and heart rate versus time, with the results from the earlier assessment.

18. The method of claim 17, wherein the comparing includes comparing changes in slope of one or more of a plot of work rate versus time, a plot of heart rate versus time, or a plot of reaction rate versus time.

19. The method of claim 17, wherein the comparing includes comparing one or more intersection points overlaid plots of work rate versus time, and heart rate versus time.

20. The method of claim 15, wherein the comparing includes determining progress of fitness training from the comparing with the results from the earlier assessment.

21. The method of claim 20, wherein the comparing includes determining whether overtraining is occurring.
